(19) United States
(12) Patent Application Publication
(10) Pub. No.: US 2008/0162468 A1
(43) Pub. Date: Jul. 3, 2008

(54) METHOD OF AND APPARATUS FOR SELECTING CHARACTERISABLE DATASETS

(75) Inventors: Tobias Frohlich, Berlin (DE); Oliver Koch, Hamburg (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Teravolt GbR, Hamburg (DE)

(21) Appl. No.: 11/956,249

(22) Filed: Dec. 13, 2007

(30) Foreign Application Priority Data
Dec. 19, 2006 (DE) 20 2006 019 225.5
Oct. 31, 2007 (DE) 102007052.3345-53

(51) Int. Cl. G06F 17/30

(52) U.S. Cl. 707/5; 707/E17.108

(57) ABSTRACT

The invention concerns a method and an apparatus for providing an individually sorted sequence of elements. An apparatus according to the invention of that kind comprises: a storage device wherein there is stored a plurality of elements and in relation to each element a description set in which there is stored in relation to the respective element with regard to each of at least three criteria a conformity value by which the conformity of the respective element with the criterion is assessed, a user interface which makes it possible for a user to select at least two criteria from a plurality of criteria and to select a weighting factor between the two criteria, which determines which of the two criteria is to be taken into account preferredly in relation to the other criterion, and a sorting device which constructs a sequence of elements and is adapted to arrange a first element before a second element when the conformity value for the first criterion which the user has selected as preferred is higher in the description set of the first element than the conformity value for the first criterion in the description set of the second element, and/or the conformity value for the second criterion which the user has selected as less preferred is lower in the description set of the first element than the conformity value for the second criterion in the description set of the second element.

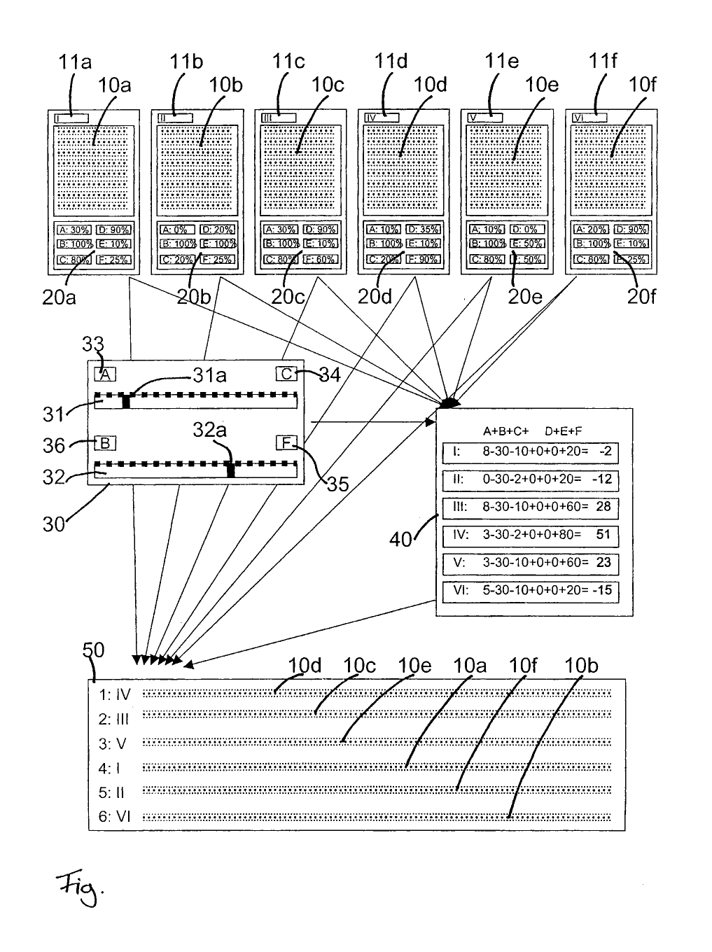

The invention concerns an apparatus for and a method of providing an individually sorted sequence of elements. The method according to the invention and the apparatus according to the invention are suitable in particular for providing articles sorted in an individual sequence or datasets which describe such articles or other datasets such as for example datasets which include audio or video data files or describe people.

Individual sorting of such articles or datasets is necessary whenever a sequence is to be produced from a large number of elements, which permits a user simplified, more convenient or more clearly laid out, more personal use of the data. By way of example it is often desirable and known in the provision of audio data to produce an individual playlist by a procedure whereby the user implements a search for example through the total available audio data files on the basis of a criterion such as the name of a given artist, a given style of music or a title of a given album, and only those audio data files which have the criterion inputted by the user are incorporated into the playlist.

Another use by way of example in which such sorting is desired is to be found for example in relation to seeking a partner by way of organisations which can arrange that, in respect of which it is known for the search for a partner to be defined by the input of personality characteristics and to produce a sorted sequence of partners who best match the inputted personality features.

A fundamental problem in regard to the sorting method which is previously known of that nature is that it is only possible for the user to sort the elements on the basis of binary checking of one or a plurality of criteria. In that respect the term binary checking is used to mean that the elements are checked to ascertain whether a criterion which has been predetermined by the user is or is not satisfied. It is in that way admittedly possible to sort elements in accordance with hard objective criteria and to provide the elements corresponding to the criterion, but that manner of sorting and providing the elements cannot achieve satisfactory results if the situation involves sorting on the basis of criteria which are less accessible to such a binary form of consideration. Thus for example when providing and sorting audio data files, sorting can only be inadequately effected in accordance with a given style of music on the basis of a binary selection as pieces of music can often be attributed to a number of different styles, but in that respect fall rather into one style than the other or however are rather to be classified between two styles. In the other example of use for example the provision and sorting of person-related data can be only inadequately used for sorting, on the basis of the criterion of hair color, as the actual hair color of each person is typically represented in a highly individual form and occurs as an intermediate form between the terms which are familiar for describing hair such as ‘black’, ‘brown’, ‘blond’ and the like.

In regard to the field of providing a sorted sequence of music files, it is known to give an assessment relating to criteria of music files, for example to assess a given style of music on the basis of a four-stage assessment scale and then to provide the music files in a sorted sequence on the basis of the assessment result. In that way titles of pieces of music of a style of music which has received a good assessment can be sorted further up in the sorting sequence than titles of pieces of music with a style of music which received a worse assessment. That sorting method admittedly makes it possible to achieve gradual weighting of criteria when sorting the elements, but on the one hand there is still the problem that this method also does not make it possible to effect sorting on the basis of criteria which are not accessible to such an objective definition while on the other hand the known method suffers from the disadvantage that there are only ever individual criteria that are predetermined for the user, which he can assess in the above-discussed staged fashion in order to influence the sorting procedure.

A further deficiency with the existing methods lies in the process of modifying result lists which have already been established. If a result list has been produced with the selection options which are complicated and expensive to set and if thereafter there should be a wish to modify the result list, that can only be achieved by going back into the setting mask again and setting flags or removing set flags. It is not possible to directly see what effect that modification has for the result list has first to be subsequently generated again.

Those known methods are not suitable for the typical user behaviour as they can only inadequately go into the criteria which objectively can be less precisely adopted. It is precisely those criteria however that are highly relevant for providing an individually sorted sequence.

Therefore the object of the invention is to provide an apparatus and a method permitting the provision of elements sorted in a sequence, in respect of which such criteria which are not accessible to a clearly distinguishable definition can be better taken into consideration.

In accordance with a first aspect of the invention that object is attained with an apparatus of the kind set forth in the opening part of this specification, wherein the apparatus includes: a storage device wherein there is stored a plurality of elements and in relation to each element a description set in which there is stored in relation to the respective element with regard to each of at least three criteria a conformity value by which the conformity of the respective element with the criterion is assessed, a user interface which makes it possible for a user to select at least a first and a second criterion from a plurality of criteria and to mutually associate them, and to select a weighting factor between the two selected and mutually associated criteria, which determines which of the two criteria is to be taken into account preferredly in relation to the other criterion in sorting a sequence of the elements, and a sorting device which constructs a sequence of elements and is adapted to arrange a first element before a second element when the conformity value for the first criterion which the user has selected as preferred in relation to the second criterion is higher in the description set of the first element than the conformity value for the first criterion in the description set of the second element, and/or the conformity value for the second criterion which the user has selected as less preferred in relation to the first criterion is lower in the description set of the first element than the conformity value for the second criterion in the description set of the second element. The user can thus on the one hand freely select the criteria but alternatively the criteria which can be altered can be fixedly predetermined by the apparatus.

After a first sequence has been established the user can immediately modify each criterion in predefined graduations or steplessly, the effect achieved thereby on the sequence/sorting is in practice displayed in real time. The latter can possibly still not be available in the first version.

Added to that there is then also the production of the playlist which in turn follows its own specific rules: implementation in terms of content (for example no two top-ten hits in succession, control of the use of clips, rotations), implementation in respect of time (for example weekday wake-up and weekend party offers).

The apparatus according to the invention makes it possible to achieve a substantial improvement in the provision of individually sorted sequences of elements.

Firstly the apparatus according to the invention includes a storage device which in particular can be a data memory in which there are stored a plurality of elements but which can also include a physical storage arrangement for article things. Besides the elements, a description set is stored in the storage device, in relation to each element. The description set contains information which permits characterisation of the respective element in regard to given criteria, in accordance with the invention it is provided that such a characterisation is effected for each element, at least for three criteria. Characterisation is effected in the description set by the storage of a conformity value which represents a measurement of the extent to which the element with which the description set is associated is in conformity with the criterion. An example of such a conformity value could for example be such that a piece of music in a first criterion with a conformity of 100% is attributed to the rock style of music while in a second criterion with a conformity of 60% it is associated with the pop style of music, whereby an individual style of music of pop-rock is established for the piece of music in question, which is rather pop-dominant. The conformity value however can also involve a binary statement in relation to a plurality of different criteria, for example by only the criteria pop and rock being specified in the description set without implementing a percentage association with the respective criterion.

The apparatus according to the invention further has a user interface. The user interface makes it possible for a user on the one hand to select at least two criteria from the plurality of available predetermined criteria and to associate those at least two criteria with each other. In accordance with the invention, a second function of the user interface involves determining a weighting factor between the two criteria which in that way are selected and associated with each other. That possibility of selecting, associating and weighting two criteria in relation to each other affords the user a possible way of influencing the sorting of the sequence of the elements to be provided, which is superior to the previous, previously known possibilities and which makes it possible to have an influence which is more pragmatic from the point of view of the user. Accordingly, with the method according to the invention, the user can not only influence the selection of a specific piece of music or a specific style of music by assessment of the piece of music or the style of music with a given assessment stage, but with the apparatus according to the invention he can weight two styles of music relative to each other. That makes it possible on the one hand for the user to select two criteria such as for example styles of music which he would like to know are both listed in a given relationship in the sorted sequence. On the other hand, this also makes it possible for the user to associate a criterion which he prefers and a criterion which he rejects with each other and to shift the weighting to the favor of the preferred criterion in order thereby to achieve a specifically targeted increase in the consideration given to elements in the sorted sequence, which comply with the preferred criterion, and to implement that increase in consideration to the detriment of elements which correspond to the less preferred criterion.

Finally the apparatus according to the invention includes a sorting device which then sorts the elements in a sequence and provides them for the user in such a way that, on the basis of the weighting factor determined by the user between the two criteria, elements which rather correspond to the more heavily weighted criterion are arranged before elements which less correspond thereto and/or which correspond to the less heavily weighted criterion more than other elements. That provides that, in the sorted sequence, those elements which correspond more greatly to the criterion which is preferably weighted by the user are arranged further towards the front and those elements which correspond less greatly to that more heavily weighted criterion or which rather more greatly correspond to the criterion which is less greatly weighted by the user are arranged further back in the sequence. That therefore provides for positive forward positioning on the one hand on the basis of the first criterion and negative rearward positioning on the other hand on the basis of the second criterion.

The sorting device provides for that operation of determining the sequence insofar as it draws on the criteria on the one hand on the basis of the weighting factor inputted by the user and then compares same with the conformity values in the description set in relation to the plurality of elements in order in that way to identify elements whose conformity value with the more heavily weighted criterion is very high and to arrange them at the front in the sequence and on the other hand to arrange further back elements whose identity value with the more heavily weighted criterion is only low and in the same manner also to arrange at the back elements whose conformity value with the less heavily weighted criterion is high or to arrange elements possibly further towards the front, whose conformity value with the less heavily weighted criterion is low.

The criteria with which the sorting device operates are preferably quantitatively objectivatable metadata, that is to say order criteria which are established in accordance with disclosed reference parameters such as for example video level (city, country, building, articles, people), audio level (BPM, instrumentation, vocals, sounds), production/object-related level (author, artist, year of production, length, format).

In a first preferred embodiment of the invention the sorting device includes a calculation unit which is adapted to ascertain from the weighting factor between the two selected and mutually associated criteria a first rank factor for the first criterion, which is correspondingly higher, the greater the weighting factor has been set to the favor of the first criterion, and a second rank factor for the second criterion, which is correspondingly higher, the greater the weighting factor has been set to the favor of the second criterion, an assessment unit which is adapted to calculate a rank value for a plurality of the elements, preferably for each of the elements stored in the storage device, which rank value is composed of a rank value portion for each criterion, wherein a rank value portion of a criterion for an element is correspondingly higher, the higher the rank factor for the criterion is and the correspondingly higher the conformity value is in the description set of the element in relation to said criterion, and a sorting unit which is adapted to arrange the plurality of elements and preferably all elements stored in the storage device in a sequence in which an element is arranged before another element if the sum of its rank value portions is higher than that of the other element.

The sorting device which is developed in that fashion permits separate consideration to be given to the first and second criterion on the basis of the respective conformity value for said criterion in the description sets of the elements, such consideration being calculated from the weighting factor which the user inputted by way of the user interface. That development is highly suitable on the one hand for effecting sorting on the basis of only two mutually associated criteria. In particular that development however is suitable for effecting sorting when the user has selected more than two criteria and associated them with each other, for example additional two criteria or additional four criteria in order then, on the basis in each case of two or three criteria which are associated with each other in paired relationship and criteria which are weighted in relation to each other, to calculate the corresponding rank value portions for each criterion in relation to each element and to effect sorting on the basis of that totalling of those rank value portions.

In addition it is preferable if the rank factor for a criterion is positive if it is more greatly weighted in relation to the other criterion associated therewith and the rank factor for a criterion is negative if it is less heavily weighted in relation to the other criterion associated therewith. That makes it possible for positive and negative assessment of the criteria to be combined together.

It is even more preferred if stored in the storage device is an association table in respect of the criteria, in which associated with each criterion is one or more criteria in complementary or quasi-complementary relationship, wherein criteria which are associated with each other as complementary are contradictory relative to each other, and criteria which are associated with each other as quasi-complementary are conflicting with each other, the user interface is adapted to permit a user to select at least one first criterion from a plurality of criteria, the user interface includes a selection unit which is adapted to provide the user with a selection from at least one and preferably a plurality of other criteria which are complementary or quasi-complementary to the first criterion, and the user interface is adapted to display the selection to the user, allows him to select the second criterion from the selection of the criterion/the criteria, and to associate the selected second criterion with the first criterion.

In that development, on the basis of a first criterion he has selected, the user is afforded a proposal in respect of other criteria which are actually or almost in opposition with the previously selected first criterion. In that way it is possible with the apparatus according to the invention to effect simplified weighting of criteria which have been previously associated with each as complementary or quasi-complementary respectively in the association table in order to permit the user, in a simplified and inherently logic fashion, selection, association and weighting of two criteria. In a practical implementation the association can be effected as complementary or quasi-complementary respectively by a procedure which for example, in relation to the criterion of the language of interpretation, selects in opposite relationship to a first criterion ‘German’ in relation to a piece of music, the complementary characterisation ‘English’, ‘French’, which is put to the user for selection, or which for example, in respect of the criterion concerning the style of music ‘hard rock’, adopts in opposite relationship the quasi-complementary styles of music ‘blues’, ‘soul’ or the like, and makes same available to the user for selection.

In that respect it is particularly preferred if the selection unit is adapted to select a second criterion which is complementarily associated as a single one with the selected first criterion and to associate it with the first criterion. That development makes it possible that, when the user has identified a single unique complementary counter-criterion by virtue of the selection of the first criterion, it no longer has to be expressly selected by the user as a second criterion, but that selection is implemented by the apparatus in an automated procedure.

It is further preferred if the user interface is adapted to permit the user to select two criteria and associate them with each other, which are neither complementary nor quasi-complementary relative to each other. That development of the apparatus according to the invention capitalises on a specific advantage of the association and weighting of two criteria relative to each other, in accordance with the invention, insofar as two character-foreign criteria are weighted relative to each other. In that respect the term ‘character-foreign’ is used to mean that the two criteria are not associated with a common generic term but that they describe different characterisation fields. In that way, by means of a few inputs, the user can move the apparatus according to the invention to a sorting which he prefers. By way of example, when the user would primarily like to listen to pieces of music in the English language, but in that respect would primarily like to listen to female artists performing the pieces of music, he can select ‘English-language text’ as the first criterion and ‘male artists’ as the second criterion and then set the weighting factor to the favor of the English-language text.

It is further preferred if stored in the description set relating to each element are conformity values in relation to criteria which describe the elements in respect of two different characterisation fields and the user interface is adapted to enable the user to select two criteria which describe the elements in respect of two different characterisation fields, to associate them with each other and to weight them against each other. That development provides in particular for the above-described individualised weighting of different characterisation fields in order thereby to achieve the desired individual sorting for a user by means of a few inputs.

In addition the apparatus according to the invention can be further developed in that the user interface includes an analog selection device, in particular a rotary or slide regulator, for selection of the weighting factor between two criteria, wherein the limit values or limit abutments of the rotary or slide regulator represent a 100% weighting of the one criterion or the other criterion respectively. That configuration provides for intuitively operable determination of the weighting factor, that in addition is typically graduated and/or can be steplessly regulated. In that respect it is to be appreciated that the analog selection device can be embodied in the form of actual physical operating elements or can be in the form of virtual representations which can be varied for example on a display screen and by means of keyboard inputs or a mouse cursor.

It is further preferred if the criteria include a first group of indispensable criteria which must be defined to arrive at a selection and sequence of elements and which are taken into consideration in producing the selection and sequence, and a second group of dispensable criteria which can be selectively determined and taken into consideration in producing the selection and sequence only when they are determined. With that development it is possible that a first group of indispensable criteria and associated weighting factors has to be selected by the user, a second group of dispensable criteria and associated weighting factors can be selectively determined and subsequently the selection and sequence of elements is effected on the basis of all indispensable criteria and only those dispensable criteria which are determined. Thus production of the sequence can be blocked unless all indispensable criteria have been selected and weighted.

Finally a further development of the apparatus according to the invention can provide that the user interface is adapted to permit the selection of at least four, preferably a larger even number, of criteria, to associate two respective criteria from the selection with each other and to weight them relative to each other, the sorting device including a calculation unit which is adapted to ascertain from the weighting factor between two respective selected and mutually associated criteria a rank factor for each criterion, which is correspondingly higher, the greater the weighting factor has been set to the favor of the respective criterion, an assessment unit which is adapted to calculate for a plurality of elements, preferably each of the elements stored in the storage device, a rank value which is composed of a rank value portion for each criterion, wherein a rank value portion of a criterion for an element is correspondingly higher, the higher the rank factor is for the criterion and the higher the conformity value in the description set of the element is in relation to that criterion, and a sorting unit which is adapted to arrange the plurality of elements, preferably all elements stored in the storage device, in a sequence in which an element is arranged before another element if the sum of its rank value portions is higher than that of the other element.

That development provides that the user can weight in mutually paired relationship a plurality of criteria which are associated with each other in paired relationship, for determining the sorting sequence, in order thereby to achieve differentiated sorting. Thus on the one hand the user can effect weighting between English-language text and male artists with two mutually associated first and second criteria and, with two further mutually associated third and fourth criteria, he can effect weighting in accordance with pieces of music from the Eighties and the music style of pop, in order then to provide that sorting is effected by the sorting device according to the invention in accordance with the set weighting factors for the two pairs of criteria.

In addition it is preferred if the apparatus according to the invention is developed by a correction device/a regulating means which is adapted to alter the sequence of the elements, in particular to ensure an implementation which is dramatically appropriate in the program:
on the basis of consideration of a daytime-dependent factor with which predetermined criteria are multiplied and thereby weighted more or less heavily,
on the basis of consideration of a negative association list which associates with each other elements which should not be arranged in directly successive relationship in the sequence and separates said elements from each other by at least one further element,
on the basis of consideration of an editorial factor with which predetermined elements in the sequence are displaced forwardly,
on the basis of consideration of a repetition value which specifies that given elements are to be arranged a plurality of times in the sequence and defines the corresponding repetition quantity, and/or
on the basis of consideration of a manual change by an administrator.

That development provides that the selection made by the user by way of the criterion selection and weighting operation and the sequence produced therefrom can be subsequently modified in a given fashion. By way of example for reasons of harmony or drama it is frequently desirable for given elements not to be arranged in immediate succession in a sequence, but to be arranged separated from each other by at least one element. That negative association can take place on the one hand on the basis of an actual association of the elements with each other or can occur by checking and comparison of the criteria of the subsequent elements, for example by the musical time and speed (beats per minute) of successive pieces of music being compared together and by re-sorting possibly being effected in order to deliberately avoid jumps in musical time between two successive datasets or deliberately to produce same. Furthermore re-sorting which is dependent on time of day or year is preferred, in which for example elements which correspond to a typical atmosphere of a user at a given time of day or year are preferably arranged towards the front.

In addition it is often desirable for given elements which are to be more vigorously brought to the attention of the user to be arranged further forwardly in the sequence and consequently to be shifted forwardly from a position in the sequence. In addition such elements can be arranged at a number of locations in the sequence, that is to say repeated at given spacings. That is appropriate for example for elements to which the attention of the user is to be more vigorously directed. For that purpose a list of properties of such elements which is preferably regularly updated can be stored in the apparatus according to the invention. Using that list, the elements defined therein on the basis of their properties are taken over into the sequence from the list at the corresponding repetition rate in the context of revision by the correction unit.

In addition it is advantageous if a sequence once produced by the apparatus according to the invention can also be subsequently modified by a person such as an administrator, for example in order to incorporate given artistic demands, and the correction device affords that processing option.

The data with which the correction unit operates are preferably qualitatively assessing metadata, that is to say values which define a target group or use and are associated with those target groups or uses, such as for example mood (sun-downer, dinner, romance, party), time of year/day, interests (sport (snowboard, cross-golf), culture, politics, business), genders (male, female).

Finally it is further preferred if the apparatus according to the invention also includes: a reproduction unit, in particular a reproduction unit for acoustic reproduction of elements which represent audio datasets, or a reproduction unit for the graphic representation of elements which represent video datasets. That development provides a compact selection, sorting and reproduction apparatus which usefully provides a user with all technical functions, required for individual sorted reproduction of elements.

In accordance with a further aspect of the invention the above-mentioned object is attained by a method of sorting elements such as articles, persons or datasets, comprising the steps storing a plurality of elements and a description set in relation to each element which contains in relation to the respective element in regard to each of at least three criteria a conformity value by which the conformity of the respective element with the criterion is assessed, selecting and mutually associating a first and second criterion with each other, and determining a weighting factor between the two selected and mutually associated criteria, which determines which of the two criteria is to be placed preferably in relation to the other criterion upon sorting of a sequence of the elements, producing a sequence of elements in which a respective first element is arranged before a second element when the conformity value for the first criterion which the user selected as preferred in relation to the second criterion is higher in the description set of the first element than the conformity value for the first criterion in the description set of the second element, and/or the conformity value for the second criterion which the user selected as less preferred in relation to the first criterion is lower in the description set of the first element than the conformity value for the second criterion in the description set of the second element.

The method according to the invention is particularly suitable for being carried out on the apparatus according to the invention. In that respect it is to be appreciated that the individual method steps do not have to be carried out physically at one location but can be distributed to portions of the apparatus according to the invention, which are physically separated from each other. Thus for example the method according to the invention can be carried out over a data network in which the user at a user interface arranged where he is, for example a computer or a mobile telephone, implements the required selection parameters for selection, association and weighting of the criteria and those selection parameters are communicated to a storage and sorting device arranged at a spacing in order here to hold the corresponding elements and the description sets thereof in readiness, to effect sorting on the basis of the parameters inputted by the user and to communicate the sequence then produced to the user and to provide it for him. In that respect provision can involve on the one hand actually physically making the elements, such as for example the data, available, or communication implemented in real time of the data in order to listen to them on a playback station of the user without in that respect the data being provided physically to the user for re-use.

The method according to the invention can be developed as set forth in claims 14-22. The developments of the method of such configurations are particularly suitable for being carried out on the corresponding, above-discussed developments of the apparatus according to the invention. As described hereinbefore, in that respect it is not necessarily the case that all method steps have to be performed on a physically unitary apparatus but can also be carried out on different apparatuses which are physically spaced from each other. In regard to the specific advantages and additional description in respect of the developments of the method attention is to be directed to the description relating to the corresponding aspects of the apparatus.

A preferred embodiment of the invention is described hereinafter with reference to the accompanying FIGURE showing a procedure illustrated in diagrammatic form of the method according to the invention as can be carried out within an apparatus according to the invention.

The embodiment of the invention set forth by way of example includes a storage device in which six music data files 10a-f are stored. A description set 20a-f is associated with each music file 10a-f and stored with that music file in the storage device. In addition each music file is provided with an individual identification 11a-f which permits simple identification of the music file on the basis of a short code.

A total of six criteria A-F are specified in the description sets 20a-f and stored in relation to each of those six criteria A-F is a percentage number which represents a conformity value with the respective criterion A-F. In the specified example the criterion A identifies the topicality of the respective music title, the criterion B specifies whether the artist performing the music of that title is male, the criteria C, D and E specify the extent to which the piece of music is to be correspondingly associated with the style pop, rock and soul and the criterion F specifies the extent to which this involves a piece of music with a fast beat.

A user interface 30 makes available to the user two slide regulators 31, 32 on which he can set an analog value by means of a slider 31a, 32a along a scale steplessly or in steps between two limit abutments. The user interface further makes it possible for the user to select a criterion for the respective limit abutments of the slide regulators 31, 32 and to set them in corresponding limit abutment fields 33-36. At the illustrated setting of the user interface 30 the user has set the criterion A for the first slide regulator 31 in the field 33 of the left-hand limit abutment and the criterion C in the field 34 of the right-hand limit abutment. For the second slide regulator 32 the user has set the criterion B in the field for the left-hand limit abutment and the criterion F in the field for the right-hand limit abutment. In addition the user has so set the sliders 31a, 32a that in regard to the first slide regulator they have a tendency to be displaced in the direction of the left-hand limit abutment while in regard to the second slide regulator they have a tendency to be displaced in the direction of the right-hand limit abutment. In that way the user expresses the fact that as a tendency he would like to know rather more up-to-date titles are taken into consideration (criterion A more heavily weighted by the slider 31a) and as a tendency he would like to know pop titles are less taken into consideration (criterion C assessed by the slide regulator 31a) and in addition as a tendency he would like to hear fewer male artists and preferably rather hear pieces of music involving a fast beat (criterion B down-valued by the slide regulator 32 and the criterion F valued upwardly by the slide regulator 32).

In an assessment unit 40 the user settings inputted by way of the user interface 30 are inputted and compared to the values stored in the description sets 20a-f. A rank factor is ascertained for each criterion. A rank value portion is ascertained for each of the description sets or each of the pieces of music 10a-f, in relation to each criterion, on the basis of the rank factor and the respective conformity value, and the corresponding six rank value portions for the criteria A-F are added. In that respect it is to be borne in mind that the rank value portions for the criteria A, D-F are positively taken into consideration while the rank value portions for the criteria B and C are negatively weighted as the rank factor for those criteria is negative. The rank value portions for the criteria D and E which are not involved in the selection are assessed at 0.

From the totals ascertained in that way in respect of the rank value portions for each criterion, there is a rank value of −2 for the piece of music 1, a rank value of −12 for the piece of music 2, a rank value of 28 for the piece of music 3, and so forth. Then, on the basis of those rank values, the pieces of music are sorted in a sorting device 50, insofar as those pieces of music which have the highest rank value are right at the front in the sorted sequence and those pieces of music which least correspond to the criteria inputted by the user and the weighting of those criteria are last. In the illustrated embodiment the sorting is IV-III-V-I-II-VI.

Then, the playlists/pieces of music 10a-f are compiled for the user in the sorted sequence produced in that way. Thereafter final production is effected by the regulating means which ensures the configuration which is correct in dramatic terms.

The embodiment illustrated in the FIGURE provides that criteria which have been selected by the user and in relation to which the slider was displaced are positively taken into consideration in the procedure of totalling the rank value portions and criteria which were selected and in relation to which however the slider was not displaced are negatively taken into consideration in the totalling procedure. That makes it possible for the user also to effect negative determination of given criteria, besides positive determination of given criteria. As a consequence of that assessment system arranging the slider exactly in the middle between two selected criteria would then provide that those criteria are not taken into consideration, that is to say they are assessed with 0.

In a modification of that assessment scheme, it is also possible to provide that the rank value portions of selected criteria are positively taken into consideration without exception. In that assessment method each of the selected criteria is positively taken into consideration when summing the rank value portions and the position of the slide regulator determines a factor which influences the level of the rank value portion and turns out correspondingly higher, the more the slide regulator is displaced in relation to the respective criterion of the rank value portion. That assessment method makes it possible for the user to weight up two criteria positively relative to each other, but in that case not to include the one criterion as a negative portion in the overall assessment.

1. An apparatus for providing an individually sorted sequence of elements such as articles, persons or datasets, comprising:
a storage device wherein there is stored a plurality of elements and in relation to each element a description set in which there is stored in relation to the respective element with regard to each of at least three criteria a conformity value by which the conformity of the respective element with the criterion is assessed,
a user interface which makes it possible for a user
i. to select at least a first and a second criterion from a plurality of criteria and to mutually associate them, and
ii. to select a weighting factor between the two selected and mutually associated criteria, which determines which of the two criteria is to be taken into account preferredly in relation to the other criterion in sorting a sequence of the elements, and
a sorting device which constructs a sequence of elements and is adapted to arrange a first element before a second element when
i. the conformity value for the first criterion which the user has selected as preferred in relation to the second criterion is higher in the description set of the first element than the conformity value for the first criterion in the description set of the second element, and/or
ii. the conformity value for the second criterion which the user has selected as less preferred in relation to the first criterion is lower in the description set of the first element than the conformity value for the second criterion in the description set of the second element.

2. The apparatus of claim 1 wherein the sorting device includes
a calculation unit which is adapted to ascertain from the weighting factor between the two selected and mutually associated criteria
i. a first rank factor for the first criterion, which is correspondingly higher, the greater the weighting factor has been set to the favor of the first criterion, and
ii. a second rank factor for the second criterion, which is correspondingly higher, the greater the weighting factor has been set to the favor of the second criterion,
an assessment unit which is adapted to calculate a rank value for a plurality of the elements, preferably for each of the elements stored in the storage device, which rank value is composed of a rank value portion for each criterion, wherein a rank value portion of a criterion for an element is correspondingly higher, the higher the rank factor for the criterion is and the correspondingly higher the conformity value is in the description set of the element in relation to said criterion, and
a sorting unit which is adapted to arrange the plurality of elements and preferably all elements stored in the storage device in a sequence in which an element is arranged before another element if the sum of its rank value portions is higher than that of the other element.

3. The apparatus of claim 2 wherein the rank factor for a criterion is positive if it is more greatly weighted in relation to the other criterion associated therewith and the rank factor for a criterion is negative if it is less heavily weighted in relation to the other criterion associated therewith.

4. The apparatus of claim 1 wherein
stored in the storage device is an association table in respect of the criteria, in which associated with each criterion is one or more criteria in complementary or quasi-complementary relationship, wherein
i. criteria which are associated with each other as complementary are contradictory relative to each other, and
ii. criteria which are associated with each other as quasi-complementary are conflicting with each other,
the user interface is adapted to permit a user to select at least one first criterion from a plurality of criteria,
the user interface includes a selection unit which is adapted to provide the user with a selection from at least one and preferably a plurality of other criteria which are complementary or quasi-complementary to the first criterion, and
the user interface is adapted to display the selection to the user, allows him to select the second criterion from the selection of the criterion/the criteria, and to associate the selected second criterion with the first criterion.

5. The apparatus of claim 4 wherein the selection unit is adapted to select a second criterion which is complementarily associated as a single one with the selected first criterion and to associate it with the first criterion.

6. The apparatus of claim 1 wherein the user interface is adapted to permit the user to select two criteria and associate them with each other, which are neither complementary nor quasi-complementary relative to each other.

7. The apparatus of claim 1 wherein stored in the description set relating to each element are conformity values in relation to criteria which describe the elements in respect of two different characterisation fields and the user interface is adapted to enable the user to select two criteria which describe the elements in respect of two different characterisation fields, to associate them with each other and to weight them against each other.

8. The apparatus of claim 1 wherein the user interface includes an analog selection device, in particular a rotary or slide regulator, for selection of the weighting factor between two criteria, wherein the limit values or limit abutments of the rotary or slide regulator represent a 100% weighting of the one criterion or the other criterion respectively.

9. The apparatus of claim 1 wherein the criteria include a first group of indispensable criteria which must be defined to arrive at a selection and sequence of elements and which are taken into consideration in producing the selection and sequence, and a second group of dispensable criteria which can be selectively determined and taken into consideration in producing the selection and sequence only when they are determined.

10. The apparatus of claim 1 wherein
a. the user interface is adapted to permit the selection of at least four, preferably an even number, of criteria, to associate two respective criteria from the selection with each other and to weight them relative to each other,
b. the sorting device includes:
i. a calculation unit which is adapted to ascertain from the weighting factor between two respective selected and mutually associated criteria a rank factor for each criterion, which is correspondingly higher, the greater the weighting factor has been set to the favor of the respective criterion,
ii. an assessment unit which is adapted to calculate for a plurality of elements, preferably each of the elements stored in the storage device, a rank value which is composed of a rank value portion for each criterion, wherein a rank value portion of a criterion for an element is correspondingly higher, the higher the rank factor is for the criterion and the higher the conformity value in the description set of the element is in relation to that criterion, and
iii. a sorting unit which is adapted to arrange the plurality of elements, preferably all elements stored in the storage device, in a sequence in which an element is arranged before another element if the sum of its rank value portions is higher than that of the other element.

11. The apparatus of claim 1 further comprising a correction device/a regulating means which is adapted to alter the sequence of the elements, in particular:
on the basis of consideration of a daytime-dependent factor with which predetermined criteria are multiplied and thereby weighted more or less heavily,
on the basis of consideration of a negative association list which associates with each other elements which should not be arranged in directly successive relationship in the sequence and separates said elements from each other by at least one further element,
on the basis of consideration of an editorial factor with which predetermined elements in the sequence are displaced forwardly,
on the basis of consideration of a repetition value which specifies that given elements are to be arranged a plurality of times in the sequence and defines the corresponding repetition quantity, and/or
on the basis of consideration of a manual change by an administrator.

12. The apparatus of claim 1 further comprising a reproduction unit, in particular a reproduction unit for acoustic reproduction of elements which represent audio datasets, or a reproduction unit for the graphic representation of elements which represent video datasets.

13. A method of sorting elements such as articles, persons or datasets, comprising the steps:
a. storing a plurality of elements and a description set in relation to each element which contains in relation to the respective element at least in regard to each of three criteria a conformity value by which the conformity of the respective element with the criterion is assessed,
i. selecting and mutually associating a first and second criterion with each other, and
ii. determining a weighting factor between the two selected and mutually associated criteria, which determines which of the two criteria is to be placed preferably in relation to the other criterion upon sorting of a sequence of the elements,
b. producing a sequence of elements in which a respective first element is arranged before a second element when
i. the conformity value for the first criterion which the user selected as preferred in relation to the second criterion is higher in the description set of the first element than the conformity value for the first criterion in the description set of the second element, and/or
ii. the conformity value for the second criterion which the user selected as less preferred in relation to the first criterion is lower in the description set of the first element than the conformity value for the second criterion in the description set of the second element.

14. The method of claim 13 wherein
a. ascertained from the weighting factor between the two selected and mutually associated criteria is a first rank factor for the first criterion, which is correspondingly higher, the greater the weighting factor has been set to the favor of the first criterion,
b. a second rank factor is ascertained for the second criterion, which is correspondingly higher, the greater the weighting factor has been set to the favor of the first criterion,
c. for each respective element of a plurality of elements, preferably all stored elements, a rank value portion is calculated for each criterion, wherein a rank value portion of a criterion for an element is correspondingly higher, the higher the respective rank factor for the criterion is and the higher the respective conformity value in the description set of the element in relation to that criterion is,
d. for each of the plurality of the elements or all stored elements, a rank value is calculated, which is composed of the total of the rank value portions of the respective element for each criterion, and
e. the plurality of elements and preferably all stored elements are sorted in such a way that an element is arranged before another element if its rank value is higher than that of the other element.

15. The method of claim 13 wherein one or more criteria is associated as complementary or quasi-complementary with each criterion, and wherein
i. criteria which are associated with each other as complementary are contradictory relative to each other, and
ii. criteria which are associated with each other as quasi-complementary are conflicting with each other,
b. at least a first criterion is selected from a plurality of criteria,
c. a selection from at least one and preferably a plurality of other criteria which are complementary or quasi-complementary to the first criterion is provided,
d. the selection is displayed, and
e. a second criterion is selected from the selection and associated with the first criterion.

16. The method of claim 13 wherein a second criterion which is complementarily associated as a single one with the selected first criterion is selected and is associated with the first criterion.

17. The method of claim 13 wherein two criteria are selected and mutually associated, which are neither complementary nor quasi-complementary with each other.

18. The method of claim 13 wherein stored in the description set relating to each element are conformity values in relation to criteria which describe the elements in respect of two different characterisation fields and two criteria which describe the elements in respect of two different characterisation fields are selected, associated with each other and weighted against each other.

19. The method of claim 13 wherein the weighting factor between two mutually associated criteria is selected in analog fashion and steplessly between two limit values which represent a 100% weighting of the one criterion or the other.

20. The method of claim 13 wherein
a. at least four and preferably a larger even number of criteria is selected, two respective criteria therefrom are associated with each other and weighted relative to each other,
b. ascertained from the weighting factor between two respective selected and mutually associated criteria is a respective rank factor for each criterion, which is correspondingly higher, the greater the weighting factor was set to the favor of the respective criterion,
c. for each element of a plurality of elements, preferably each of the stored elements for each criterion, a rank value portion is calculated, which is correspondingly higher, the higher the rank factor for the criterion is and the higher the conformity value in the description set of the element in relation to that criterion is,
d. a rank value is calculated for each of the (plurality of the) elements by summing of the rank value portions thereof, and
e. the (plurality of the) elements are so sorted that an element is arranged before another element if its rank value is higher than that of the other element.

21. The method of claim 13 wherein a rank value for each selected criterion is calculated from the weighting factor, which rank factor is positive when the weighting factor is set to the favor of the criterion and is negative when the weighting factor is set to the disadvantage of the criterion.

22. The method of claim 13 wherein
a first group of indispensable criteria and associated weighting factors must be selected,
a second group of dispensable criteria and associated weighting factors can be selectively determined, and
the selection and sequence of elements is effected on the basis of all indispensable criteria and only those dispensable criteria which are determined.
